(19) United States
(12) Patent Application Publication
(10) Pub. No.: US 2026/0141276 A1
(43) Pub. Date: May 21, 2026

(54) MULTI-LEVEL LLM BRIDGE BETWEEN USERS IN DIFFERENT DOMAINS

(71) Applicant: SAP SE, Walldorf (DE)

(72) Inventors: Oren HAZE, Kfar-Saba (IL); Denis VOLOSHIN, Rishon Le Zion (IL)

(21) Appl. No.: 18/951,971

(22) Filed: Nov. 19, 2024

(51) Int. Cl. G06N 5/043; G06N 5/022

(52) U.S. Cl. CPC G06N 5/043; G06N 5/022

(57) ABSTRACT

A system associated with a multi-level LLM bridge may include a knowledge base data store that contains information about a plurality of enterprise domains. The multi-level LLM bridge may create an ML/DS expert LLM agent using a base LLM. The ML/DS expert LLM agent can then be fine-tuned by a supervised LLM agent to create a plurality of domain specific ML/DS LLM agents based on filtered information from the knowledge base data store. When a task is received from a user, the system determines a domain associated with the user. The received task is then routed to one of the plurality of domain specific ML/DS LLM agents in accordance with the domain associated with the user. According to some embodiments, the routed task is performed based on a user profile, a user activity, a user history, a user context, a user role or persona, a user language, etc.

### BACKGROUND

An enterprise may have employees who specialize in various domains. For example, one employee might work in the Machine Learning (“ML”)/Data Science (“DS”) domain while another employees works in the sales and marketing domain. Often, technological solutions require involving different experts from various domains who need to work together to provide an appropriate solution. For example, business personas (e.g., marketeers and/or sales experts) may need access to data and data solutions that require deep expertise of Research and Development (“R&D”) personas (e.g., data scientists and/or algorithm engineers) when leveraging ML models and predictive systems. It can be highly challenging to establish such work groups while ensuring that experts communicate well between these different domains. While working on a complex and/or abstract task, “translators” may be used between the different domains, the different personas, the different individuals, etc. These translators are usually experts in their domain who have been trained and/or learned to perform such tasks through work experience, expertise, skill sets, academic degrees, etc. The ability to perform this type of function may benefit from the use of an automated “bridge” between the various domains. In particular, it would be desirable to provide an improved multi-level Large Language Model (“LLM”) bridge in a secure, automatic, and efficient manner.

### SUMMARY

According to some embodiments, methods and systems associated with a multi-level LLM bridge may include a knowledge base data store that contains information about a plurality of enterprise domains. The multi-level LLM bridge may create an ML/DS expert LLM agent using a base LLM. The ML/DS expert LLM agent can then be fine-tuned by a supervised LLM agent to create a plurality of domain specific ML/DS LLM agents based on filtered information from the knowledge base data store. When a task is received from a user, the system determines a domain associated with the user. The received task is then routed to one of the plurality of domain specific ML/DS LLM agents in accordance with the domain associated with the user. According to some embodiments, the routed task is performed based on a user profile, a user activity, a user history, a user context, a user role or persona, a user language, etc.

Some embodiments comprise: means for accessing information in a knowledge base data store containing information about a plurality of enterprise domains; means for creating, by a computer processor of a multi-level generative AI LLM bridge, a ML/DS expert LLM agent using a base LLM; means for fine-tuning the ML/DS expert LLM agent, by a supervised LLM agent, to create a plurality of domain specific ML/DS LLM agents based on filtered information from the knowledge base data store; means for receiving a task from a user; means for determining a domain associated with the user; and means for routing the received task to one of the plurality of domain specific ML/DS LLM agents in accordance with the domain associated with the user

Some technical advantages of some embodiments disclosed herein are improved systems and methods to provide a multi-level LLM bridge in a secure, automatic, and efficient manner.

### BRIEF DESCRIPTION OF THE DRAWINGS

FIG. 1 is an example of enterprise domains.

FIG. 2 is a high-level multi-level LLM bridge system architecture in accordance with some embodiments.

FIG. 3 is a method according to some embodiments.

FIG. 4 is a more detailed view of a system in accordance with some embodiments.

FIG. 5 is a more detailed method according to some embodiments.

FIG. 6 is a system to interpret a task from one enterprise domain (e.g., marketing, sales, HR, etc.) to a task from another domain (e.g., ML/DS) and tailor results for a specific user in accordance with some embodiments.

FIG. 7 is a system to explain, ramp-up, and/or train different users from diverse domains, roles, etc. according to some embodiments.

FIG. 8 is an AI workbench display in accordance with some embodiments.

FIG. 9 is a system to provide continuous improvement via feedback learning and adaptation according to some embodiments.

FIG. 10 is an apparatus or platform according to some embodiments.

FIG. 11 is a portion of a multi-level LLM bridge database in accordance with some embodiments.

FIG. 12 illustrates a tablet computer multi-level LLM bridge display according to some embodiments.

FIG. 13 is a multi-level LLM bridge operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It can be challenging to interpret tasks from the business domain (e.g., marketing, sales, Human Resources (“HR”), etc.) to tasks from the R&D domain (e.g., ML/DS). It can be even more challenging to tailor and personalize performance for the specific user taking under consideration the different dimensions and aspects of the user, such as the user’s profile, history, behaviors, activities, role and persona (e.g., marketeer, sales manager, etc.), the domain expertise, the overall the context of the interaction.

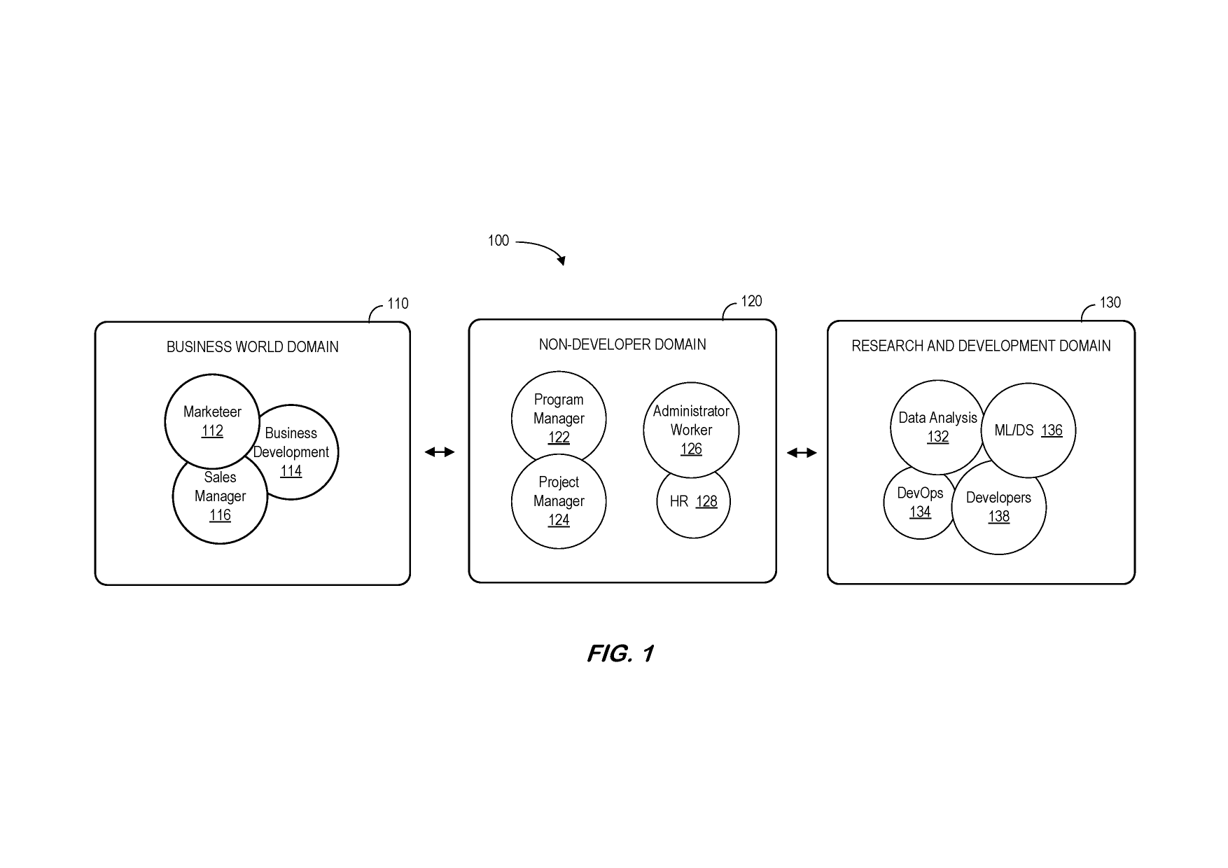

In addition, the ramp-up, training, and learning of these skills takes a lot of time, resources and it becomes particularly challenging to “explain” things and/or logic to different users from diverse backgrounds, different domains, different roles, etc. Another challenge is associated with ML model learning and adaptation. Data can flow and change rapidly, making it difficult to keep up-to-date, such as by ensuring that a solution is continually learning (e.g., in connection with risk management, compliance, enterprise goals and values, domain expertise and knowledge, etc.). FIG. 1 is an example 100 of enterprise domains that illustrates the complexity and gaps between persona from business world domains 110 (e.g., marketeer 112, business development 114, and sales manager 116), non-developer domains 120 (e.g., program manager 122, project manager 124, administrative worker 126, and HR 128), and R&D domains 130 (e.g., data analysis 132, DevOps 134, ML/DS 136, and developers 138).

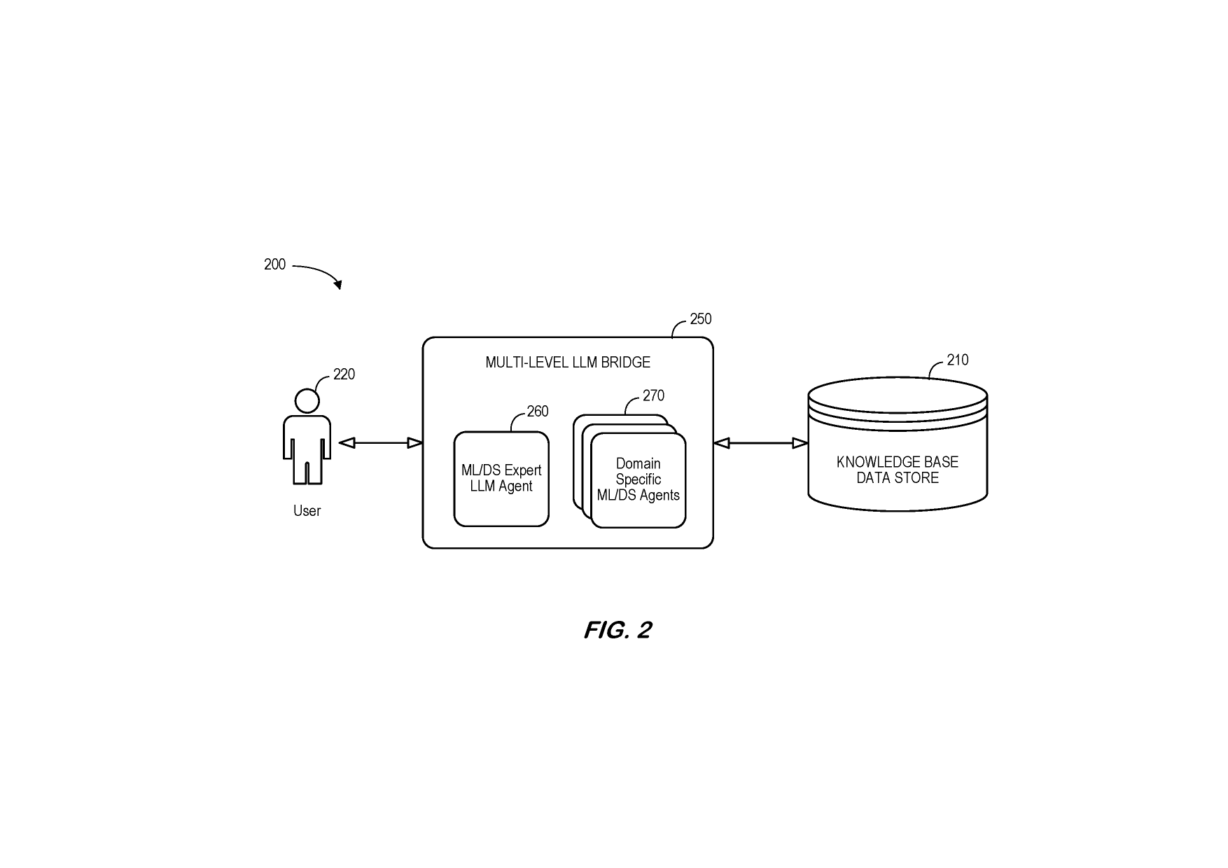

To address these issues, FIG. 2 is a high-level block diagram of one example of a system 200 architecture according to some embodiments. In particular, a multi-level LLM bridge 250 may exchange information associated with various domains with a knowledge base data store 210. The multi-level LLM bridge 250 may use a ML/DS expert LLM agent 260 and domain specific ML/DS agents 270 in response to a task received from a user 220. According to some embodiments, a remote operator or administrator device may be used to configure or otherwise adjust the system 200.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The multi-level LLM bridge 250 may store information into and/or retrieve information from various data stores (e.g., the knowledge base data store 210), which may be locally stored or reside remote from the multi-level LLM bridge 250. Although a single multi-level LLM bridge 250 is shown in FIG. 2, any number of such devices may be included. Moreover, various devices described herein might be combined according to embodiments of the present invention. For example, in some embodiments, the knowledge base data store 210 and the multi-level LLM bridge 250 might comprise a single apparatus. The system 200 functions may be performed by a constellation of networked apparatuses, such as in a distributed processing or cloud-based architecture. In some cases, the multi-level LLM bridge 250 may process information associated with a number of different enterprises.

An enterprise may access the system 200 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the bridge 250 connects with an enterprise computing environment infrastructure, to edit user profiles, etc.) and/or provide or receive automatically generated recommendations, alerts, summaries, or results associated with the system 200.

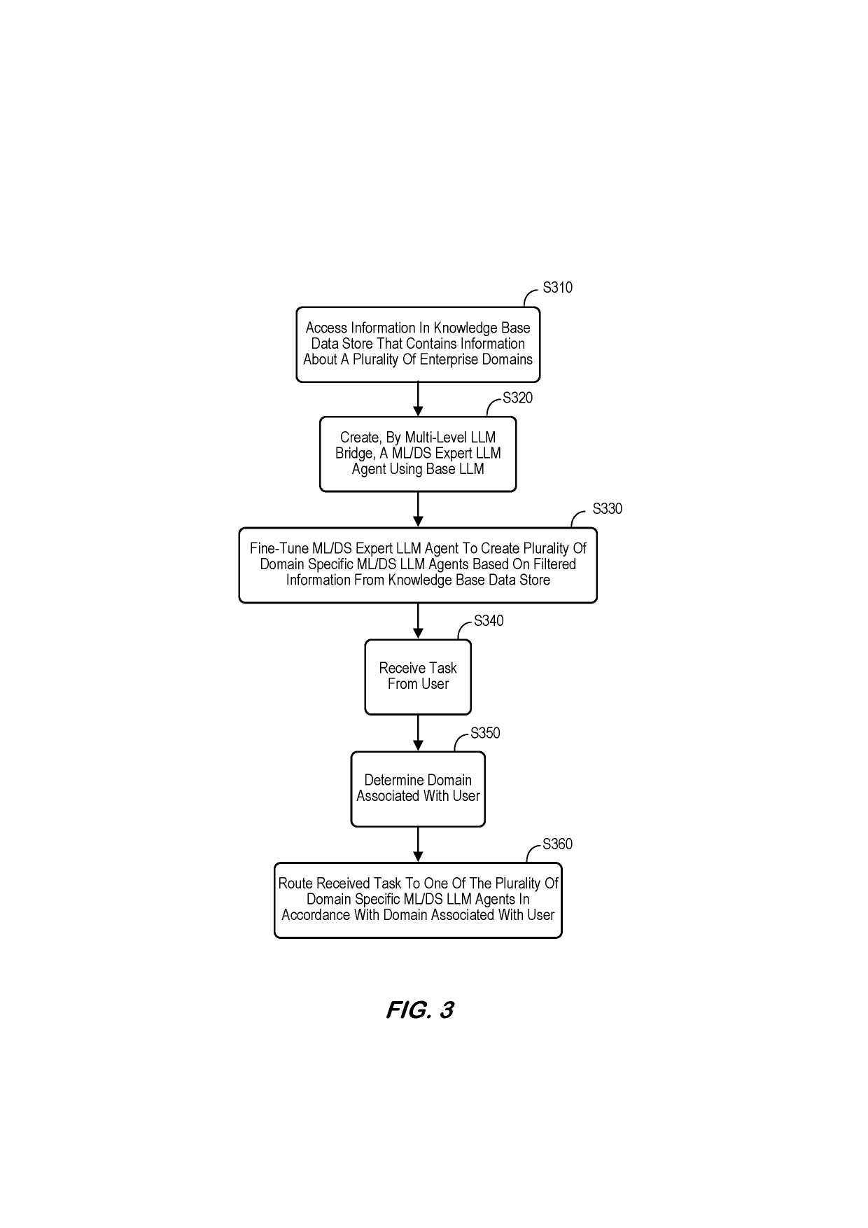

FIG. 3 is a method that might be performed by some or all of the elements of the system 200 described with respect to FIG. 2. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, embodiments may access information in a knowledge base data store that contains information about a plurality of enterprise domains. The knowledge base data store might include, for example, customer data, company data, processes, policies, wiki articles, etc. The plurality of enterprise domains might include marketing, strategy, sales, business development, HR, etc. At S320, a computer processor of a multi-level LLM bridge may create a ML/DS expert LLM agent using a base LLM (e.g., a generic LLM). Some examples of base LLMs include OPENAI™ CHATGPT®, GOOGLE™ GEMINI®, ANTHROPIC™ CLAUDE OPUS®, etc.

At S330, the ML/DS expert LLM agent is fine-tuned (by a supervised LLM agent) to create a plurality of domain specific ML/DS LLM agents based on filtered information from the knowledge base data store. At S340, a task is received from a user and a domain associated with that user is determined at S350. At S360, the system routes the received task to one of the plurality of domain specific ML/DS LLM agents in accordance with the domain associated with the user. In some embodiments, the routed task is performed based on user information, such as a user profile, a user activity, a user history, a user context, a user role or persona, a user language, a user level of expertise, a user skill set, a user preference, etc. According to some embodiments, the routed task is performed based on real-time information, such as customer data, enterprise policies, Key Performance Indicators (“KPIs”), transaction data, etc.

In some embodiments, the plurality of domain specific ML/DS LLM agents is automatically and continuously updated (e.g., based on user feedback). Moreover, an Artificial Intelligence (“AI”)/ML workbench can be used to perform model training, management, and evaluation. In some embodiments, the routed task includes translating information from one enterprise domain into another enterprise domain for the user and/or generating an explanation for the user based on an enterprise domain.

To address the challenges described herein, embodiments may introduce system and methods that compose ML solutions that let the system interpret, generate, analyze, explain, learn, and/or adapt to specific user requests. Note that embodiments may target users who do not have deep expertise in ML/DS (e.g., business users). The system may provide a low code (or no code) solution to leverage users data from multiple dimensions (e.g., persona/role, user profile, activities, domain, know-how and expertise, history, skill set, etc.). In addition, embodiments may create and maintain domain specific LLMs (e.g., a marketing LLM, a ML/DS LLM, a sales LLM, etc.), that recognize and manage different personas/roles (e.g., marketeer, sales manager, marketing operations, etc.).

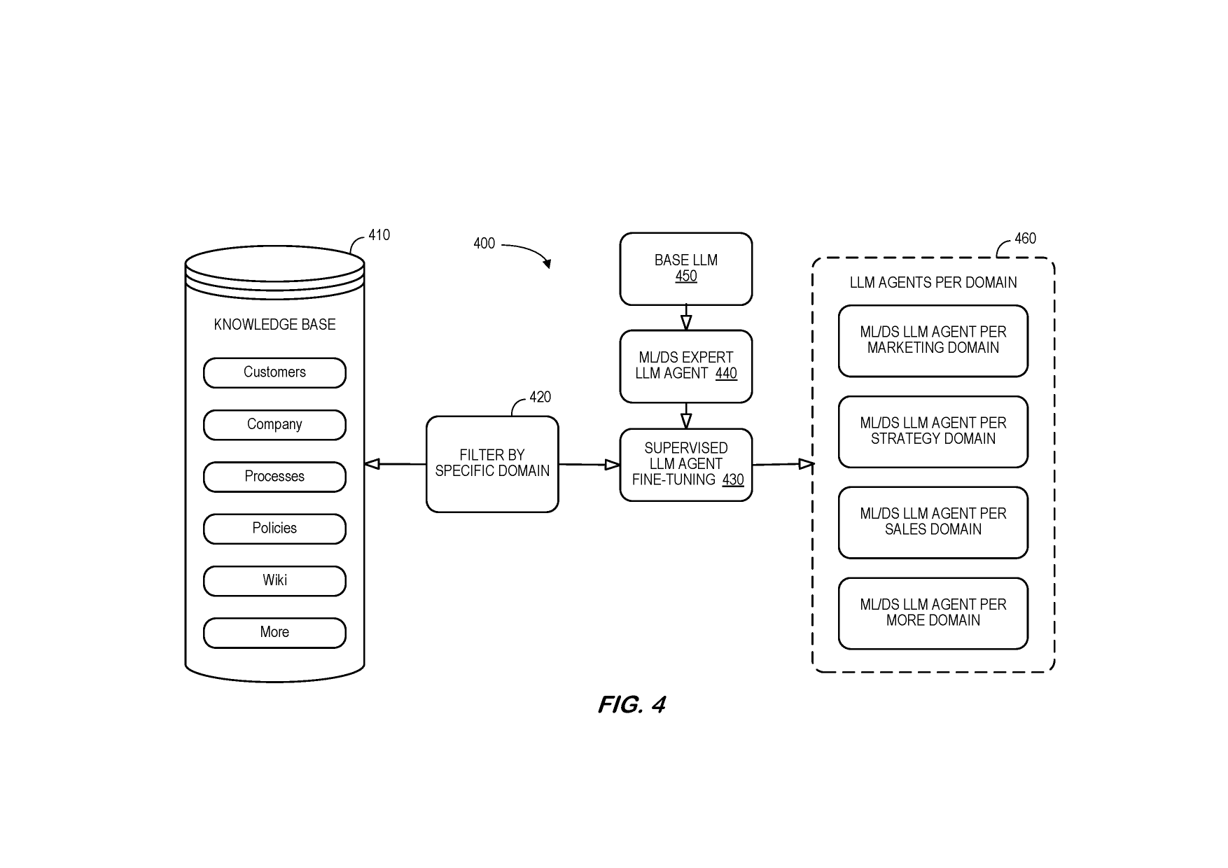

FIG. 4 is a more detailed view of a system 400 in accordance with some embodiments. A knowledge base 410 may contain information about enterprise customers, company, processes, policies, wiki, etc. This information may be filtered based on specific domains 420 and used to perform supervised LLM agent fine-tuning 430. The tuning might be associated with, for example, an ML/DS expert LLM agent 440 created from a base LLM 450 (e.g., OPENAI™ CHATGPT®, GOOGLE™ GEMINI®, ANTHROPIC™ CLAUDE OPUS®, etc.) create LLM agents per domain 460, such as an ML/DS LLM agent per a marketing domain, an ML/DS LLM agent per a strategy domain, and ML/DS LLM agent per a sales domain, etc.

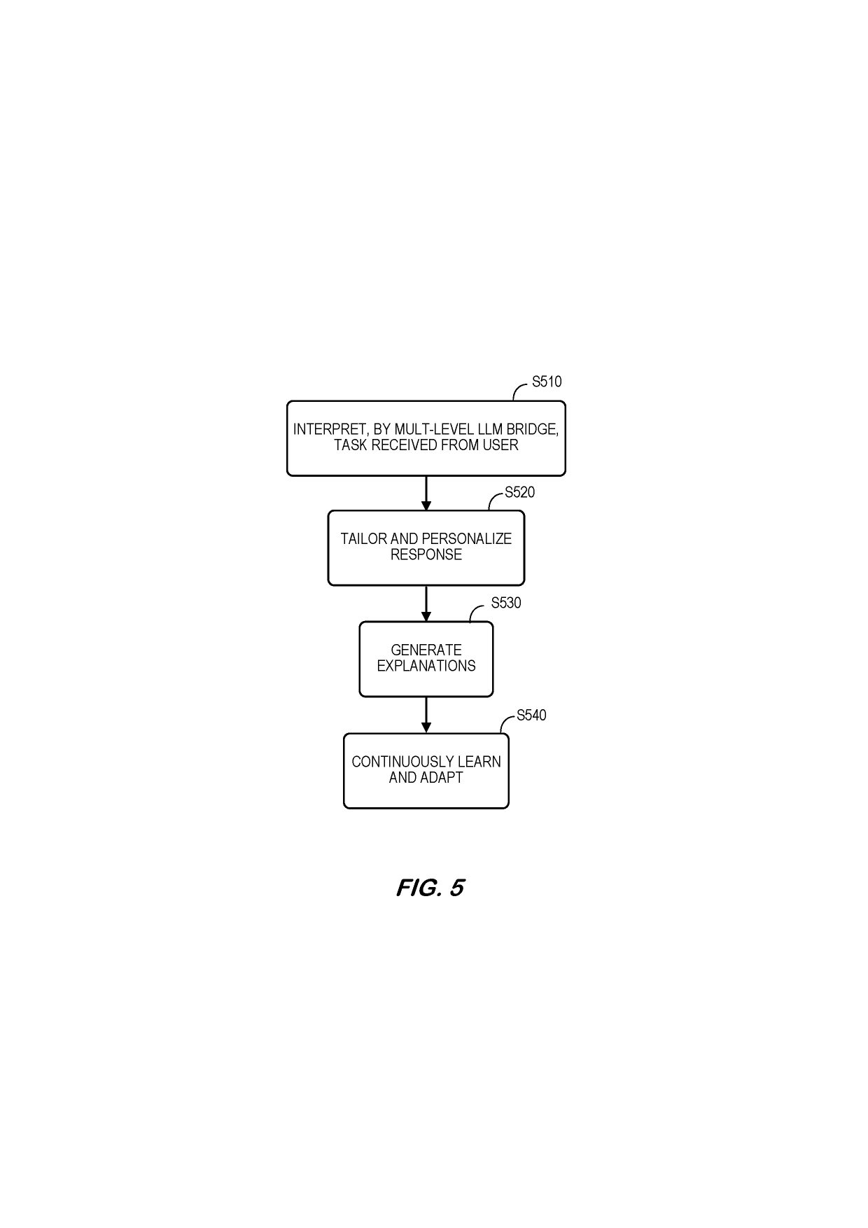

By leveraging the data and components of the system 400, embodiments may implement a multi-level LLM bridge. For example, FIG. 5 is a more detailed method according to some embodiments. At S510, a multi-level LLM bridge may interpret a task received from a user in the business domain (e.g., Marketing, Sales, Human Resources, etc.) and translate the task to the R&D domain (e.g., ML/DS).

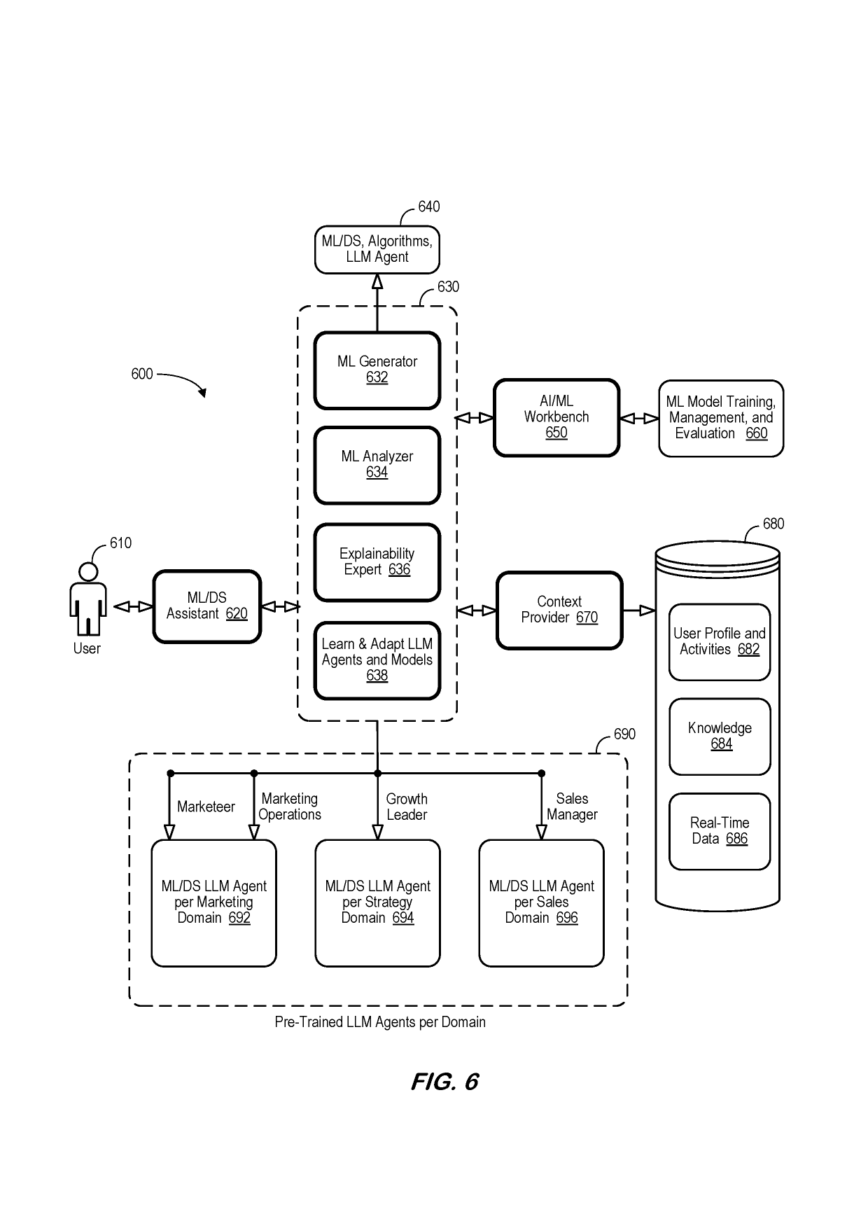

At S520, the system may tailor and personalize a response for the user who submitted the task as described in connection with FIG. 6.

(b) Tailor and personalize the system to specific user as we need to take under consideration different dimensions/aspects such as the user’s profile, history, behaviors, activities, the user’s role, and persona (e.g., an individual with extensive experience and specialized knowledge in a particular field such as a Marketeer, Sales Manager, etc.), the domain expertise (Marketing, Sales, HR, etc.), the context of the interaction, aspects of policies, processing purposes, personal data, risk management, compliance, reflecting on the organization/company’s DNA and more.

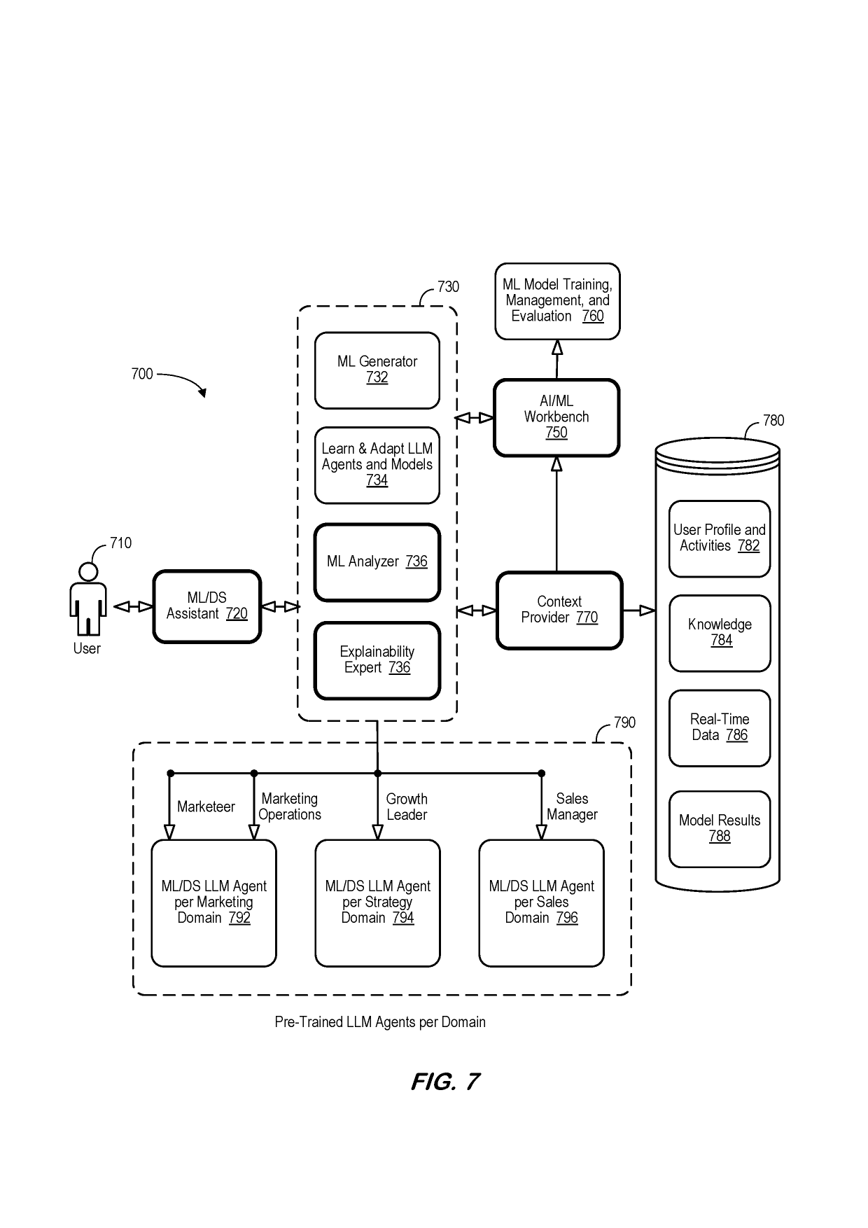

At S530, the system may generate explanations that are appropriate for various enterprise domains as described in connection with FIG. 7. From the explainability perspective, the system may be able to “explain,” ramp-up, and./or train the different users that come from diverse backgrounds, different domains, different roles, etc. As a result, it may enhance user productivity. The system may be able to identify and communicate in a user’s preferred language, communicate in a user’s domain terms (e.g., “Customer Life-time Value,” “Customer Churn,” “Propensity to Buy,” “Return On Investment,” etc.), be able to answer questions (in the style of a generative AI chat bot), be able to address topics like company policies, processing purposes, personal data, risk management, compliance, reflecting on the organization/company’s vision, and/or provide credible references for the “explanation.”

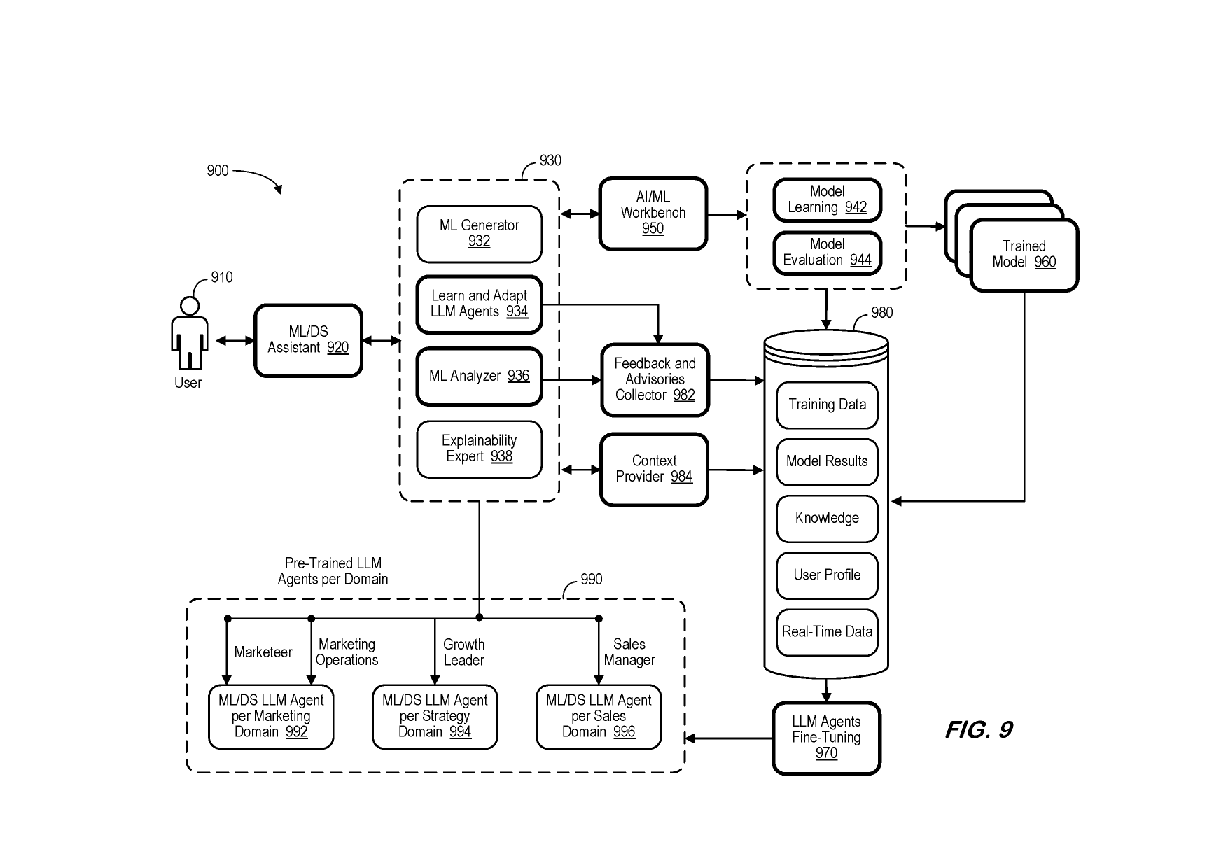

At S540, the system may continuously learn and adapt (e.g., based on user feedback) as described in connection with FIG. 9. From the learning and adaptation perspective, the system may leverage and capture the different data flows in order to make sure that all of the system’s data parts are continuously updated, that the entire solution is continually learning based on feedback from users, from an analyzer component, from updates to risk factors, changes in policies, and compliance to better reflect enterprise goals, in addition to making sure that the domain expertise and knowledge LLM-s are continuously being adapted. Moreover, each feedback type may include credible references to an appropriate source.

FIG. 6 is a system 600 that interprets a task from one enterprise domain (e.g., marketing, sales, HR, etc.) into a task for another domain (e.g., ML/DS) and tailor results for a specific user in accordance with some embodiments. A user 610 may interact with a ML/DS assistant 620 featuring a user-friendly chat interface. The ML/DS assistant 620 may manage conversational continuity (ensuring the conversation maintains a continuous state) and/or determining user intent (by analyzing a user query and context to accurately determine user intent and dispatch the request to the most relevant request processing flow).

Core system components 630 interact with the ML/DS assistant 620 and may include a ML generator 632 (per user, persona, domain, context, etc.) that interacts with ML/DS, algorithms, and an LLM agent 640 and controls the ML generation flow. The components 630 may also include a ML analyzer 634 (per user, persona, domain, context, etc.) that involves ML/DS LLM agents and controls the model’s analysis process (which continuously analyses user feedback/interactions and works closely with an AI/ML workbench 650 about ML model quality, etc.). The components 630 may further include an explainability expert 636 (per user, persona, domain, context, etc.) that uses ML/DS LLM per relevant domain to control an explainability capability. In addition, the components may include learn and adapt LLM agents and models 638 (based on feed-back, new data, KPIs, etc.) responsible for coordinating learning and adaptation capabilities. According to some embodiments, the system 600 may leverage different types of feedback (e.g., feedback from the user 610, feedback from the ML analyzer 634, feedback/data from the specific domain etc.).

The AI/ML workbench 650 control center may be responsible for different aspects of ML algorithms and model management such as the generation of new models, launching and modeling a model training process, managing sets of models, and performing evaluations to analyze model quality 660. A context provider 670 may exchange information with the components 630 and leverage prompt engineering, Retrieval-Augmented Generation (“RAG”), etc. The context provider 670 may, for example, leverage advanced AI techniques to create personalized contexts by synthesizing information from various data sources. These sources can encompass different dimensions that characterize the user to help ensure highly customized and relevant interactions with agents. For example, the context provider 670 may access information in storage 680, user profile and activities 682 (e.g., language, activities, level of expertise, skillset, role, preferences, etc.), knowledge 684, real-time data 686 (e.g., customers, policies, KPIs, transactions, etc.), a context of a model’s quality analysis, a context of a process/policy changes etc. The system may ultimately create pre-trained LLM agents per domain 690, such as a ML/DS agent per marketing domain 692, a ML/DS agent per strategy domain 694, a ML/DS agent per sales domain 696, etc.

Explainability in a multi-level LLM bridge may enable effective decision-making and ensure regulatory compliance by translating complex AI terms into language suited to a user’s expertise. For example, in data science, an AI agent might interpret a complex predictive model’s output about customer churn into actionable marketing insights, explaining that specific customer segments are at risk and suggesting targeted retention strategies tailored to a marketing professional’s understanding. This tailored explanation helps marketers grasp the AI’s recommendations and implement effective actions.

FIG. 7 is a system 700 to explain, ramp-up, and/or train different users from diverse domains, roles, etc. according to some embodiments. A ML/DS assistant 720 may help a user 710 interact with components 730. The components 730 may include, for example, a ML generator 732 (per user, persona, domain, context, etc. and communicates ML/), learn and adapt LLM agents and models 734 (based on feed-back, new data, KPIs, etc.), a ML analyzer 736 (per user, persona, domain, context, etc.), and an explainability expert 738 (per user, persona, domain, context, etc.). An AI/ML workbench 750 may help ML model training, management, and evaluation 760.

A context provider 770 may leverage prompt engineering, Retrieval-Augmented Generation (“RAG”), etc. and store information into storage 780 that can include user profile and activities 782 (e.g., language, activities, level of expertise, skillset, role, preferences, etc.), knowledge 784, real-time data 786 (e.g., customers, policies, KPIs, transactions, etc.), model results 788, etc. Pre-trained LLM agents per domain 790 might include a ML/DS agent per marketing domain 792, a ML/DS agent per strategy domain 794, a ML/DS agent per sales domain 796, etc. Thus, embodiments may improve explainability, enabling effective decision-making, and ensure regulatory compliance by translating complex AI terms into language suited to user expertise. For example, in data science an AI agent might interpret a complex predictive model’s output about customer churn into actionable marketing insights, explaining that specific customer segments are at risk and suggesting targeted retention strategies tailored to a marketing professional’s understanding. This tailored explanation helps marketers grasp the AI's recommendations and implement effective actions.

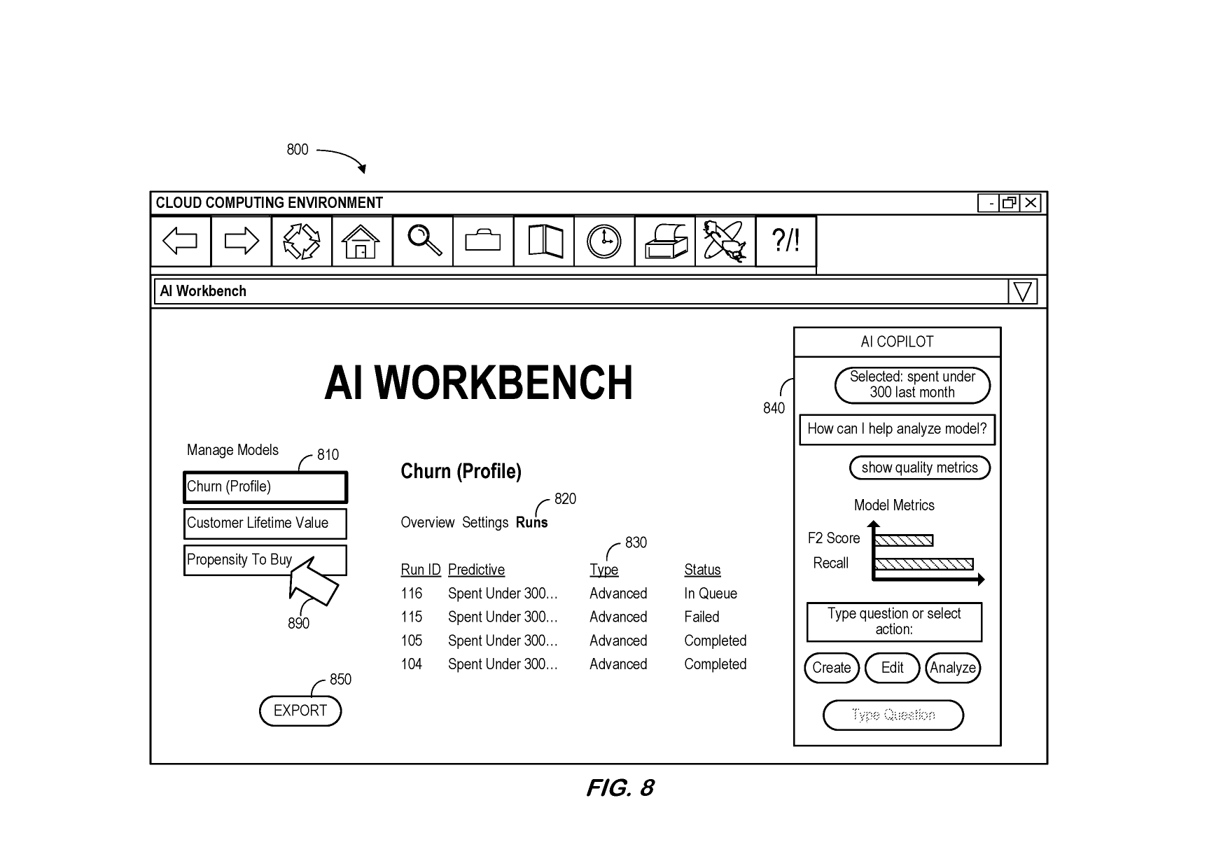

FIG. 8 is an AI workbench display 800 in accordance with some embodiments. The display 800 might be associated with a customer data platform screen for technical users. Model management options 810 may be used to select one of the models (e.g., via a computer mouse pointer 890). Navigation tabs 820 may let a user select to see information providing data about an overview, settings, and runs. A run result table 830 (e.g., including a run identifier, predictive task, run type, run status, etc.) might show the results of model runs (e.g., whether the run was completed, failed, or has been queued). An AI copilot chat user interface 840 might let a business user (e.g., a marketer) ask questions and receive relevant enterprise metrics. An “Export” icon 850 may be used to save the information in a form usable by other applications, such as a spreadsheet application.

FIG. 9 is a system 900 to provide continuous improvement via feedback learning and adaptation according to some embodiments. A user 910 may interact with components 930 via an ML/DS assistant 920. The components 930 might include, for example, a ML generator 932 (per user, persona, domain, context, etc.), learn and adapt LLM agents and models 934 (based on feed-back, new data, KPIs, etc.), a ML analyzer 936 (per user, persona, domain, context, etc.), and/or an explainability expert 938 (per user, persona, domain, context, etc.).

An AI/ML workbench 950 may help create trained models 960 (via model learning 942 and model evaluation 944) which can then update storage 980. A feed-back and advisories collector 982 may receive information from the learn and adapt LLM agents and models 934 and the ML analyzer 936, and then use that information to update the storage 980. The storage 980 might include, for example, training data, model results, knowledge, user profile and activities, real-time data, etc. A context provider 984 may leverage prompt engineering, Retrieval-Augmented Generation (“RAG”), etc. and update the storage 980. LLM agents fine-tuning 970 may use information in storage 980 to create pre-trained LLM agents per domain 990, such as a ML/DS agent per marketing domain 992, a ML/DS agent per strategy domain 994, a ML/DS agent per sales domain 996, etc.

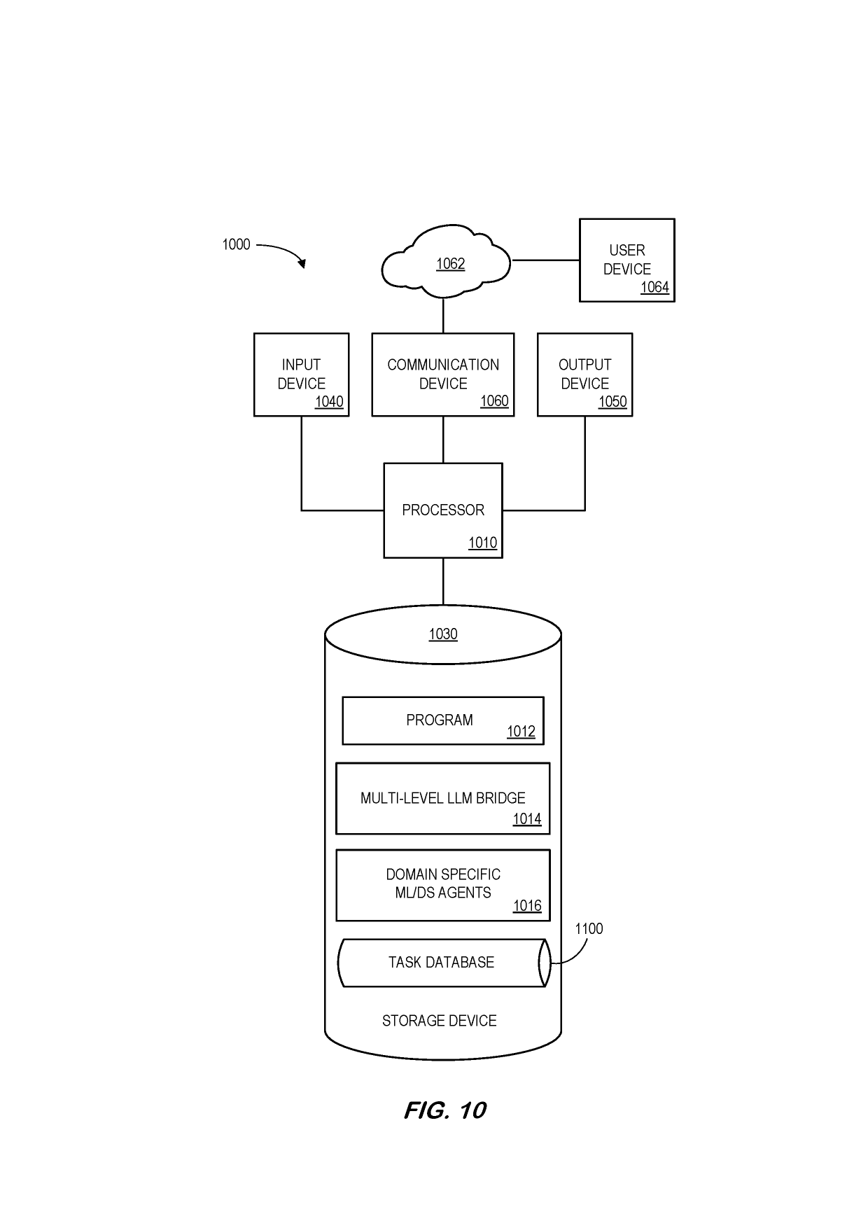

Note that the embodiments described herein may be implemented using any number of different hardware configurations. For example, FIG. 10 is a block diagram of an apparatus or platform 1000 that may be, for example, associated with the system 200 of FIG. 2 (and/or any other system described herein). The platform 1000 comprises a processor 1010, such as one or more commercially available Central Processing Units (“CPUs”) in the form of one-chip microprocessors, coupled to a communication device 1060 configured to communicate via a communication network 1062. The communication device 1060 may be used to communicate, for example, with one or more user devices 1064 via a distributed communication network 1062. The platform 1000 further includes an input device 1040 (e.g., a computer mouse and/or keyboard to input information about user domains, enterprise information, mappings, etc.) and/an output device 1050 (e.g., a computer monitor to render a display, transmit recommendations, charts, alerts, and/or reports about multi-level LLM bridge results, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012, multi-level LLM bridge 1014, and/or domain specific agents 1016 for controlling the processor 1010. The processor 1010 performs instructions of the programs 1012, 1014, 1016 and thereby operates in accordance with any of the embodiments described herein. For example, the processor 1010 may create a ML/DS expert LLM agent using a base LLM. The ML/DS expert LLM agent can then be fine-tuned by a supervised LLM agent to create a plurality of domain specific ML/DS LLM agents based on filtered information from a knowledge base data store. When a task is received from a user, the processor 1010 may determine a domain associated with the user. The received task is then routed by the processor 1010 to one of the plurality of domain specific ML/DS LLM agents in accordance with the domain associated with the user. According to some embodiments, the routed task is performed by the processor 1010 based on a user profile, a user activity, a user history, a user context, a user role or persona, a user language, etc.

The programs 1012, 1014, 1016 may be stored in a compressed, uncompiled and/or encrypted format. The programs 1012, 1014, 1016 may furthermore include other program elements, such as an operating system, clipboard application, a database management system, and/or device drivers used by the processor 1010 to interface with peripheral devices.

As used herein, information may be “received” by or “transmitted” to, for example: (i) the platform 1000 from another device; or (ii) a software application or module within the platform 1000 from another software application, module, or any other source.

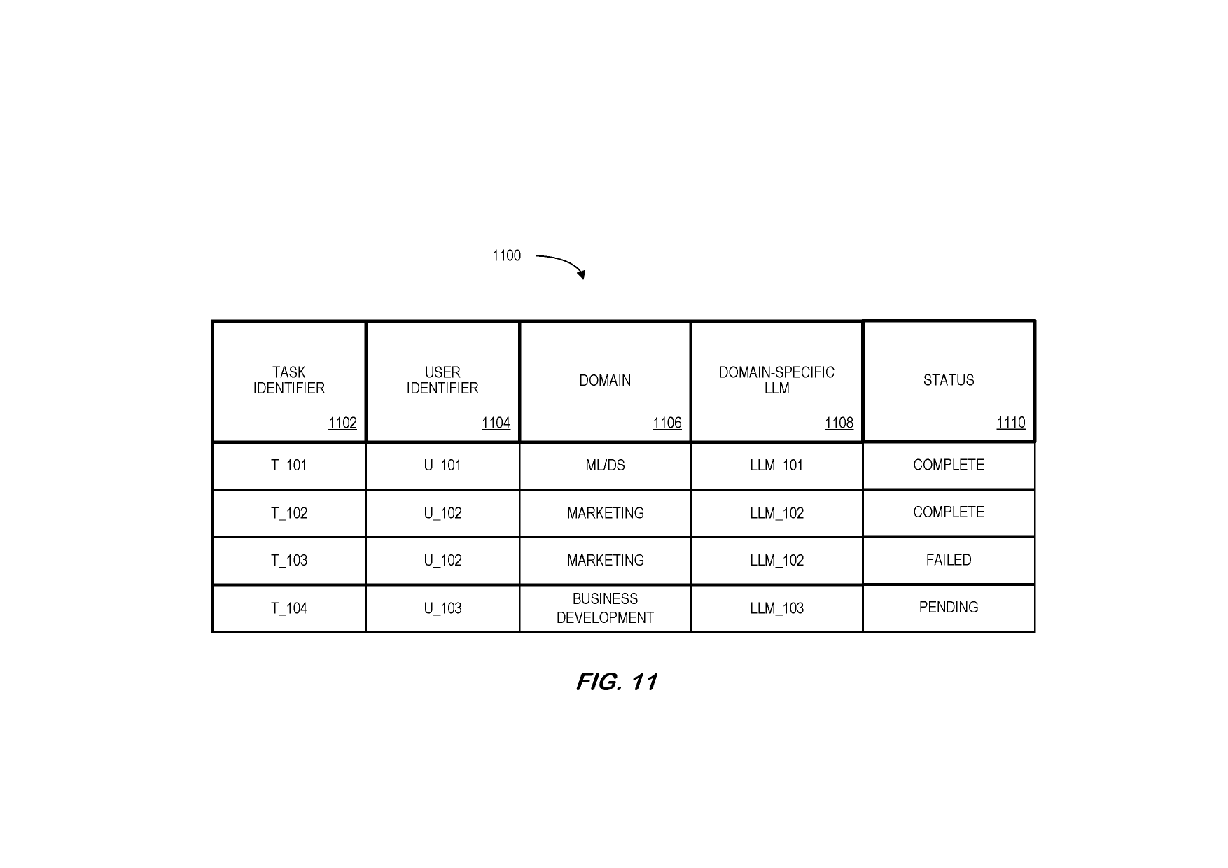

In some embodiments (such as the one shown in FIG. 10), the storage device 1030 further stores a task database 1100. An example of a database that may be used in connection with the platform 1000 will now be described in detail with respect to FIG. 11. Note that the database described herein is only one example, and additional and/or different information may be stored therein. Moreover, various databases might be split or combined in accordance with any of the embodiments described herein.

Referring to FIG. 11, a table is shown that represents the task database 1100 that may be stored at the platform 1000 according to some embodiments. The table may include, for example, entries identifying requests from ML/DS or business domain users. The table may also define fields 1102, 1104, 1106, 1108, 1110 for each of the entries. The fields 1102, 1104, 1106, 1108, 1110 may, according to some embodiments, specify: a task identifier 1102, a user identifier 1104, a domain 1106, a domain-specific LLM 1108, and a status 1110. The task database 1100 may be created and updated, for example, submits a query or task, asks to have information tailored to a specific domain or user, etc.

The task identifier 1102 might be a unique alphanumeric label that is associated with a user query, question, or request. The user identifier 1104 may indicate who submitted that task and the domain 1106 might indicate the appropriate enterprise area of expertise associated with that user identifier 1104. The domain-specific LLM 1108 may be selected by the system based on the appropriate enterprise domain 1106. The status 1110 might indicate that a task is complete, has failed, is pending in queue, etc.

In this way, embodiments may take into account domain and persona expertise (e.g., especially business domains) which can have a dramatic effect on the quality of ML results, the performance of the system, and user’s experiences. Moreover, embodiments may leverage a user’s specific data (such as a user profile, skillset, expertise, behavior, activities, history, preferences etc.) and thus can personalize and/or tailor results and actions to as specific user. In addition, embodiments may communicate with an end user in the user’s preferred language, communicate in specific domain terms (e.g., customer life-time value, return on investments, customer churn, propensity to buy, etc.). Further, embodiments may explain, teach, train, and/or ramp-up a user’s know-how and leverage and learn from user specific feedback, and/or adapt LLM domain specific knowledge with a mechanism to learn and adapt continuously and automatically.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Any of the embodiments described herein may utilize LLM-powered agents. As used herein, the phrase “LLM -powered agent” might refer to, for example, a system with complex reasoning capabilities, memory, and the means to execute tasks to reason through a problem, create a plan to solve the problem, execute the plan, etc. Such an approach may help shape the underlying behavior and rough stylistic direction of a task response.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of enterprise use cases, any of the embodiments described herein could be applied to other types of use cases.

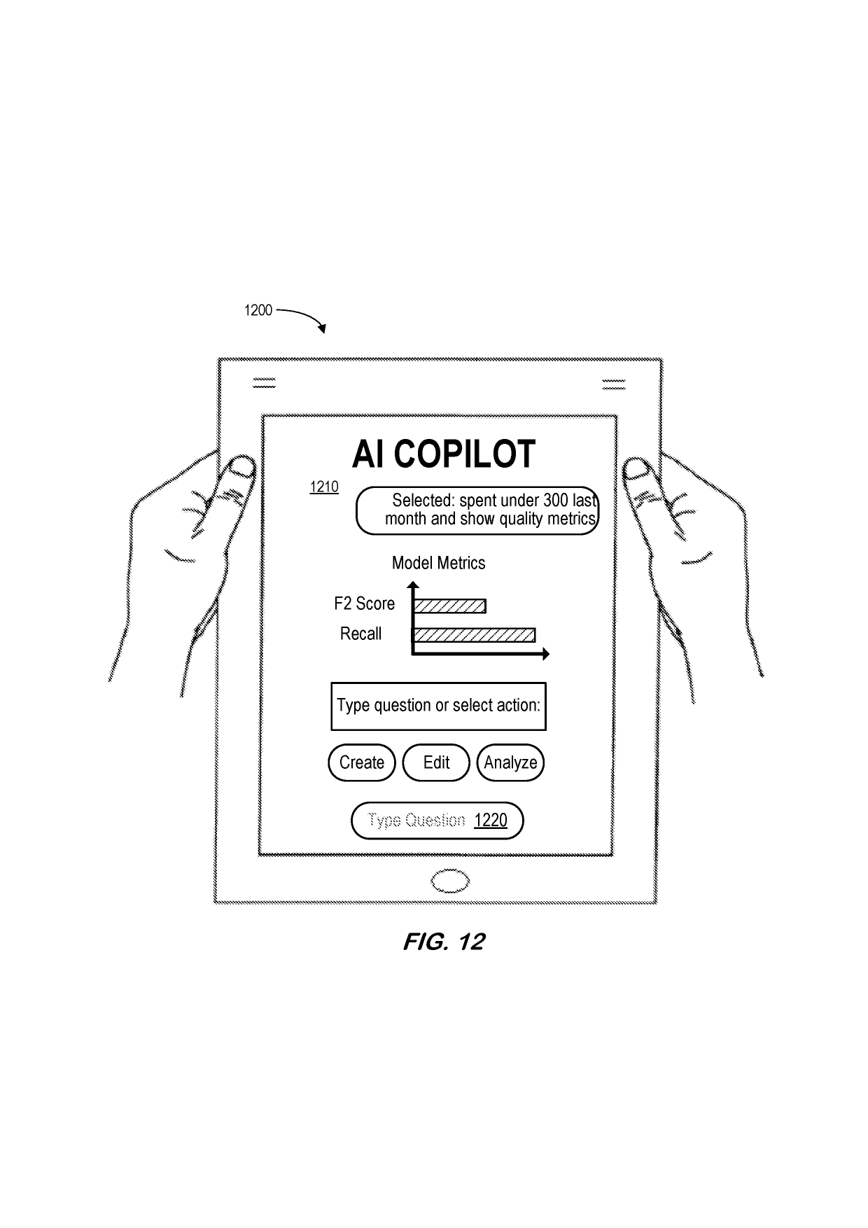

In addition, the displays shown herein are provided only as examples, and any other type of user interface could be implemented. For example, FIG. 12 illustrates a tablet computer 1200 providing a multi-level LLM bridge AI copilot display 1210 according to some embodiments. The AI copilot display 1210 might be used, for example, to let ML/DS and/or business employees associated with an enterprise submit tasks and receive appropriate responses. A user may interact with the display 1210, such as by selecting a “Type Question” text entry area 1220.

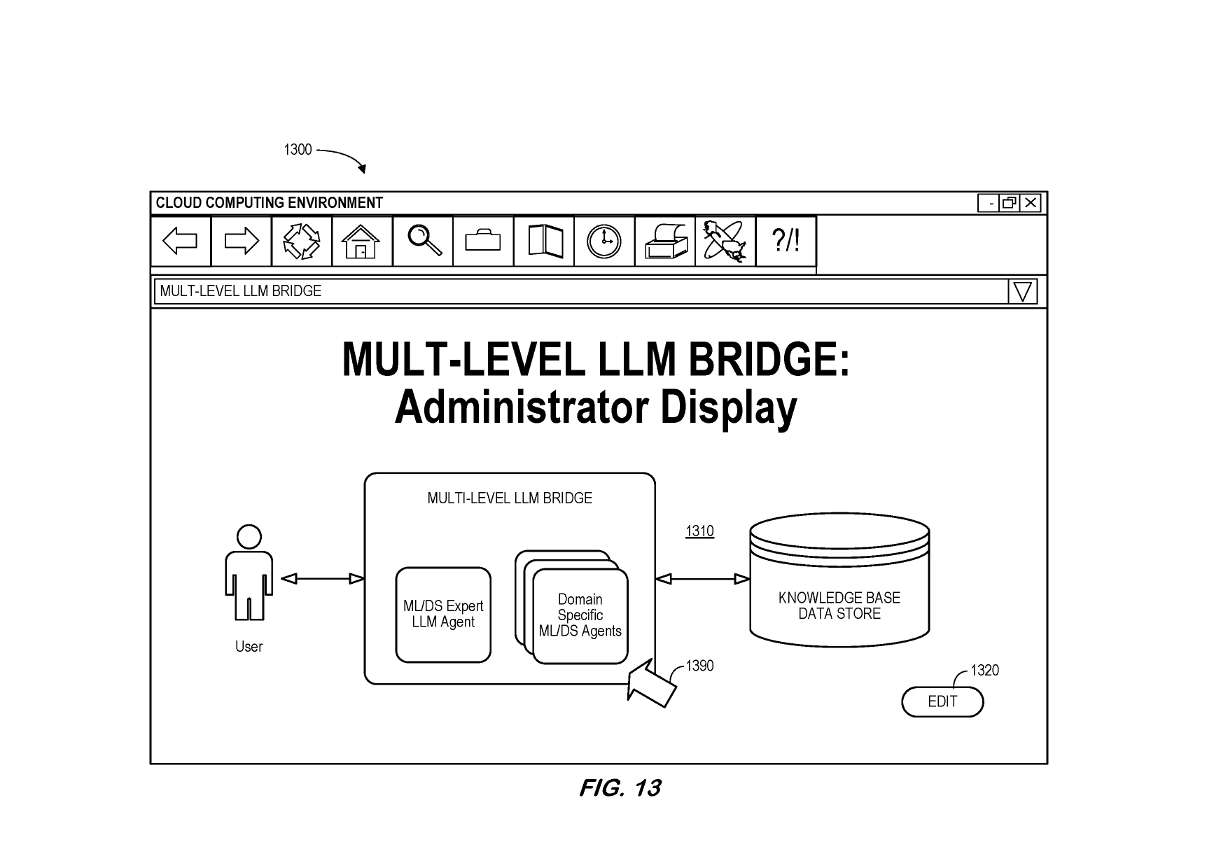

FIG. 13 is an operator or administrator display in accordance with some embodiments. The display 1300 includes a graphical representation 1310 of a multi-level LLM bridge in accordance with any of the embodiments described herein. Selection of an element on the display 1300 (e.g., via a touchscreen or computer pointer 1390) may result in display of a pop-up window containing more detailed information about that element and/or various options (e.g., to define how a multi-level LLM bridge interacts with various data stores, user devices, external resources, etc.). Selection of an “Edit” icon 1320 may also let an operator or administrator adjust the operation of the system (e.g., to change mapping to a data store, adjust object or element properties, select domain specific information and user preferences, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
a knowledge base data store containing information about a plurality of enterprise domains; and
a multi-level Large Language Model (“LLM”) bridge, including:
a computer processor, and
a computer memory storing instructions that when executed by the computer processor cause the multi-level LLM bridge to:
create a Machine Learning/Data Science (“ML/DS”) expert LLM agent using a base LLM,
fine-tune the ML/DS expert LLM agent, by a supervised LLM agent, to create a plurality of domain specific ML/DS LLM agents based on filtered information from the knowledge base data store,
receive a task from a user,
determine a domain associated with the user, and
route the received task to one of the plurality of domain specific ML/DS LLM agents in accordance with the domain associated with the user.

2. The system of claim 1, wherein the knowledge base data store includes at least one of: (i) customer data, (ii) company data, (iii) processes, (iv) policies, and (v) wiki articles.

3. The system of claim 1, wherein the plurality of enterprise domains includes at least one of: (i) marketing, (ii) strategy, (iii) sales, (iv) business development, and (v) human resources.

4. The system of claim 1, wherein the routed task is performed based on user information, including at least one of: (i) a user profile, (ii) a user activity, (iii) a user history, (iv) a user context, (v) a user role or persona, (vi) a user language, (vii) a user level of expertise, (viii) a user skill set, and (ix) a user preference.

5. The system of claim 1, wherein the routed task is performed based on real-time information, including at least one of: (i) customer data, (ii) enterprise policies, (iii) Key Performance Indicators (“KPIs”), and (iv) transaction data.

6. The system of claim 1, wherein the plurality of domain specific ML/DS LLM agents is automatically and continuously updated.

7. The system of claim 6, wherein the continuous updates are based on user feedback.

8. The system of claim 1, wherein an Artificial Intelligence (“AI”)/ML workbench is used to perform model training, management, and evaluation.

9. The system of claim 1, wherein the routed task includes translating information from one enterprise domain into another enterprise domain for the user.

10. The system of claim 1, wherein the routed task includes generating an explanation for the user based on an enterprise domain.

11. A computer-implemented method, comprising:
accessing information in a knowledge base data store containing information about a plurality of enterprise domains;
creating, by a computer processor of a multi-level Large Language Model (“LLM”) bridge, a Machine Learning/Data Science (“ML/DS”) expert LLM agent using a base LLM;
fine-tuning the ML/DS expert LLM agent, by a supervised LLM agent, to create a plurality of domain specific ML/DS LLM agents based on filtered information from the knowledge base data store;
receiving a task from a user;
determining a domain associated with the user; and
routing the received task to one of the plurality of domain specific ML/DS LLM agents in accordance with the domain associated with the user, wherein the routed task includes translating information from one enterprise domain into another enterprise domain for the user and generating an explanation for the user based on an enterprise domain.

12. The method of claim 11, wherein the knowledge base data store includes at least one of: (i) customer data, (ii) company data, (iii) processes, (iv) policies, and (v) wiki articles.

13. The method of claim 11, wherein the plurality of enterprise domains includes at least one of: (i) marketing, (ii) strategy, (iii) sales, (iv) business development, and (v) human resources.

14. The method of claim 11, wherein the routed task is performed based on user information, including at least one of: (i) a user profile, (ii) a user activity, (iii) a user history, (iv) a user context, (v) a user role or persona, (vi) a user language, (vii) a user level of expertise, (viii) a user skill set, and (ix) a user preference.

15. The method of claim 11, wherein the routed task is performed based on real-time information, including at least one of: (i) customer data, (ii) enterprise policies, (iii) Key Performance Indicators (“KPIs”), and (iv) transaction data.

16. The method of claim 11, wherein the plurality of domain specific ML/DS LLM agents is automatically and continuously updated.

17. One or more non-transitory computer-readable media storing computer-executable instructions that, when executed by a computing system, cause the computing system to perform operations comprising:
accessing information in a knowledge base data store containing information about a plurality of enterprise domains;
creating, by a computer processor of a multi-level Large Language Model (“LLM”) bridge, a Machine Learning/Data Science (“ML/DS”) expert LLM agent using a base LLM;
fine-tuning the ML/DS expert LLM agent, by a supervised LLM agent, to create a plurality of domain specific ML/DS LLM agents based on filtered information from the knowledge base data store;
receiving a task from a user;
determining a domain associated with the user; and
routing the received task to one of the plurality of domain specific ML/DS LLM agents in accordance with the domain associated with the user, wherein the plurality of domain specific ML/DS LLM agents is automatically and continuously updated.

18. The media of claim 17, wherein the continuous updates are based on user feedback.

19. The media of claim 17, wherein an Artificial Intelligence (“AI”)/ML workbench is used to perform model training, management, and evaluation.

20. The media of claim 17, wherein the routed task includes translating information from one enterprise domain into another enterprise domain for the user.

21. The media of claim 17, wherein the routed task includes generating an explanation for the user based on an enterprise domain.
